(19) United States
(12) Patent Application Publication
(10) Pub. No.: US 2026/0039700 A1
(43) Pub. Date: Feb. 5, 2026

(54) NETWORK SLICING WITH EDGE SECURITY SERVICES IN COMMUNICATION NETWORKS

(71) Applicant: T-MOBILE INNOVATIONS LLC, Overland Park, KS (US)

(72) Inventors: Sumanth Bellam Hemanth, Bothell, WA (US); Anis Adil Anis, Bay Point, CA (US); Brent Matthew Johnston, Ardmore, AL (US); Cristian Asandului, Snoqualmie, WA (US)

(21) Appl. No.: 18/794,267

(22) Filed: Aug. 5, 2024

(51) Int. Cl. H04L 9/40

(52) U.S. Cl. CPC H04L 63/20

(57) ABSTRACT

Various embodiments include a communication network that comprises a control plane and a user plane. The control plane selects a network slice for the user device in response to a session request for a user device. The session request identifies the network slice. The control plane indicates the network slice to the user device. The control plane determines the user device qualifies for enhanced slice security. The control plane updates the network slice to route user data for the user device on the network slice to an edge security service in response to determining the user device qualifies for the enhanced slice security. The user plane exchanges the user data with the user device over the network slice. The user plane routes the user data to the edge security service. The edge security service enforces security policies on the user data and delivers the user data to a data network.

### TECHNICAL FIELD

Various embodiments of the present technology relate to network slicing, and more specifically, to facilitating communication between network slices and edge security services.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Edge based security services provide security controls at a point of access instead of routing traffic to a data center where security policies are enforced. Points of access may include a user device, an Internet-of-Things (IoT) device, an access network, an edge computing location, and the like. Secure Access Service Edge (SASE) is a type of edge-based security service. SASE ensures real-time, context aware policy enforcement to secure user and device traffic. SASE comprises a flexible zero trust architecture that enforces security policies on data sessions between user devices and enterprise networks and/or the public internet. SASE encompasses a range of security solutions, including Zero Trust Network Access (ZTNA), Secure Web Gateways (SWG), Cloud Access Security Brokers (CASB), Firewall as a Service (FWaaS), and the like. This integrated approach allows SASE to provide secure and optimized connectivity to cloud services, applications, and resources from any location or device.

Wireless communication networks implement network slicing to serve wireless user devices. A network slice is a type of network partition that groups a set of RAN and core network resources that have capabilities to provide one or more service types. Network slices may be configured to provide low-latency services, media streaming services, Internet-of-Things (IoT) services, and the like. Exemplary slice types include Ultra-Reliable Low Latency Communication (URLLC), Enhanced Mobile Broadband (eMBB), Massive Internet-of-Things (MIoT), and Vehicle-to-Everything (V2X). By implementing network slicing, wireless communication networks optimize the computing and radio resources for specific service types thereby enhancing the overall user experience. Unfortunately, in some instances, wireless communication networks may not effectively or efficiently facilitate communication between wireless network slices and edge-based security services like SASE.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for network slicing. Some embodiments comprise a method. The method comprises, in response to a session request for a user device, selecting a network slice for the user device. The session request identifies the network slice. The method further comprises indicating the network slice to the user device. The method further comprises determining the user device qualifies for enhanced slice security. The method further comprises, in response to determining the user device qualifies for the enhanced slice security, updating the network slice to route user data for a session of the user device on the network slice to an edge security service. The method further comprises exchanging the user data with the user device over the network slice. The method further comprises routing the user data to an edge security service. The edge security service enforces security policies on the user data and delivers the user data to a data network.

Some embodiments comprise a communication network. The communication network comprises a control plane and a user plane. The control plane, in response to a session request for a user device, selects a network slice for the user device. The session request identifies the network slice. The control plane indicates the network slice to the user device. The control plane determines the user device qualifies for enhanced slice security. The control plane, in response to determining the user device qualifies for the enhanced slice security, updates the network slice to route user data for a session of the user device on the network slice to an edge security service. The user plane exchanges the user data with the user device over the network slice. The user plane routes the user data to the edge security service. The edge security service enforces security policies on the user data and delivers the user data to a data network.

Some embodiments comprise one or more non-transitory computer readable storage media having program instructions stored thereon. When executed by a computing system, the program instructions direct the computing system to perform operations. The operations comprise, responsive to registration authentication of a user device, retrieving subscriber attributes for the user device that indicate the user device is subscribed for secondary authentication and enhanced slice security. The operations further comprise performing the secondary authentication of the user device to enable the enhanced slice security. The operations further comprise selecting a network slice for the user device. The operations further comprise indicating the network slice to the user device. The operations further comprise exchanging user data with the user device over the network slice. The operations further comprise routing the user data to an edge security service based on the secondary authentication. The edge security service enforces security policies on the user data and delivers the user data to an enterprise network.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network.

FIG. 2 illustrates an exemplary operation of the communication network.

FIG. 3 illustrates a second exemplary operation of the communication network.

FIG. 4 illustrates a third exemplary operation of the communication network.

FIG. 5 illustrates a Fifth Generation (5G) communication network.

FIG. 6 illustrates a 5G User Equipment (UE) in the 5G communication network.

FIG. 7 illustrates a 5G Radio Access Network (RAN) in the 5G communication network.

FIG. 8 illustrates a Network Function Virtualization Infrastructure (NFVI) in the 5G communication network.

FIG. 9 further illustrates the NFVI in the 5G communication network.

FIG. 10 illustrates an exemplary operation of the 5G communication network.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

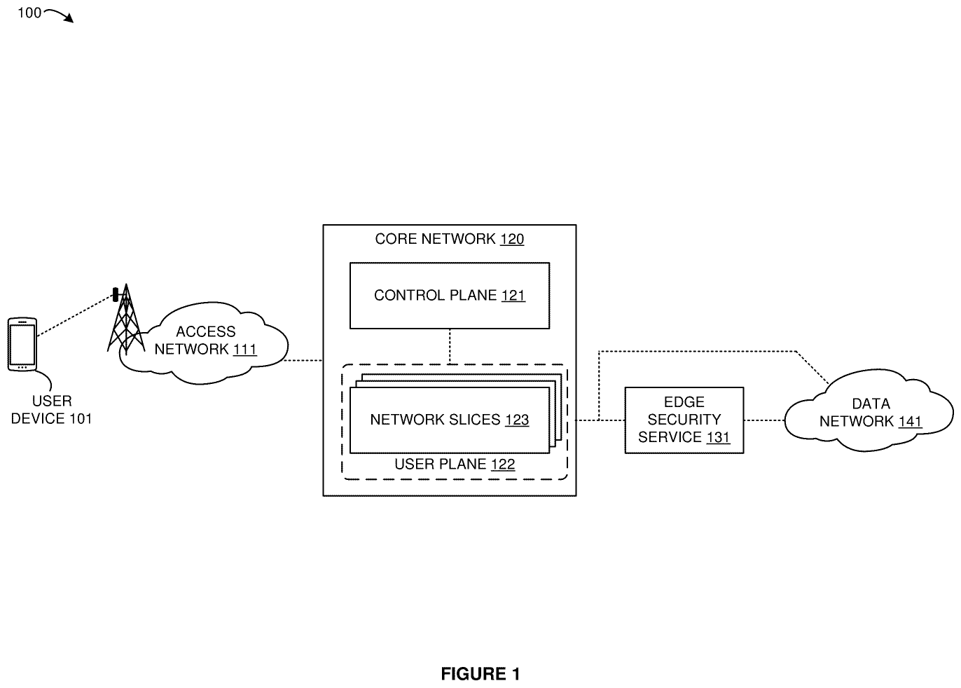

FIG. 1 illustrates communication network 100 to provide enhanced network slice security. Communication network 100 provides services like media-streaming, internet-access, voice/video calling, text messaging, online gaming, social media, machine communications, or some other wireless communications product. Communication network 100 comprises user device 101, access network 111, core network 120, edge security service 131, and data network 141. Core network 120 comprises control plane 121 and user plane 122. User plane 122 comprises network slices 123. In other examples, communication network 100 may comprise additional or different elements than those illustrated in FIG. 1.

Various examples of network operation and configuration are described herein. In some examples, user device 101 transfers a session request to control plane 121 over access network 111 to begin a data session. Control plane 121 determines when user device qualifies for enhanced slice security. Enhanced slice security refers to routing user data for a device's data session from the device's selected network slice to edge security service 131. For example, control plane 121 may access user device 101's subscriber profile stored in a network data system in core network 120 and identify subscriber attributes (e.g., service codes) that authorize user device 101 for enhanced slice security. Control plane 121 selects one or more of network slices 123 for user device 101 based on the service request and indicates the selected one(s) of network slices 123 to user device 101 over access network 111. User device 101 begins its data session. User plane 122 exchanges user data for the session with user device 101 over the selected one(s) of network slices 123. When user device 101 qualifies for enhanced slice security, user plane 122 routes the user data from the selected one(s) of network slices 123 to edge security service 131 which applies security policies for the session. Conversely, when user device 101 does not qualify for enhanced slice security, user plane 122 routes the user data from the selected one(s) of network slices 123 to data network 141 (i.e., the user data is not routed to edge security service 131). Edge security service 131 receives the data and enforces security policies (e.g., firewalls, malware detection, etc.) on the user data. Edge security service 131 delivers the secured user data to data network 141. Advantageously, communication network 100 effectively and efficiently facilitates communication between wireless network slices and edge-based security services to enhance network slice security.

User device 101 comprises a vehicle, drone, robot, computer, phone, sensor, or another type of data appliance with wireless and/or wireline communication circuitry. User device 101 and access network 111 communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access network 111 is illustrated as a tower, access network 111 may comprise another type of mounting structure (e.g., a building), or no mounting structure at all. Access network 111 comprises a Sixth Generation (6G) Radio Access Network (RAN), Fifth Generation (5G) RAN, LTE RAN, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Access network 111 exchanges network signaling and user data with control plane 121 and user plane 122 clustered together into core network 120. Access network 111 is connected to core network 120 over backhaul data links. Access network 111 and core network 120 may communicate via edge networks like internet backbone providers, edge computing systems, or another type of edge system to provide the backhaul data links between access network 111 and core network 120.

Access network 111 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUS handle higher wireless network layers like the Radio Resource Control (RRC), Service Data Adaption Protocol (SDAP), and Packet Data Convergence Protocol (PDCP). The CUs are coupled to network functions in core network 120. Access network 111 may comprise Baseband Units (BBUs). The BBUs handle lower and higher network layers like RRC, PDCP, RLC, MAC, and PHY. The BBUs are coupled to network entities in core network 120.

Core network 120 is representative of computing systems that provide wireless data services to user device 101 over access network 111. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access network 111, core network 120, edge security service 131, and data network 141 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols. The computing systems of core network 120 store and execute the network functions/entities to form control plane 121 and user plane 122. Control plane 121 may comprise control plane network functions like Access and Mobility Management Function (AMF), Session Management Function (SMF), Authentication Server Function (AUSF), Network Slice Selection Function (NSSF), Policy Control Function (PCF), Unified Data Management (UDM), Authentication, Authorization, and Accounting (AAA) server, and the like. User plane 122 comprises network functions like User Plane Function (UPF) and the like.

Network slices 123 are representative of collections of network elements (e.g., UPFs, RANs, etc.) with capabilities to support different service types over access network 111. For example, a first one of network slices 123 may comprise low-latency capabilities to support low-latency data sessions while a second one of network slices 123 may comprise high-uplink bandwidth capabilities to support media broadcasting sessions. Exemplary network slice types include Ultra-Reliable Low-Latency Communications (URLLC), Enhanced Mobile Broadband (eMBB), Massive Internet-of-Things (MIoT), Vehicle-to-Anything (V2X), and the like. While illustrated as composing user plane 122, portions of network slices 123 may reside in control plane 121, access network 111, or in other locations within communication network 100.

Edge security service 131 comprises a cloud-based computing system that applies security policies on data sessions between core network 120 and data network 141. Edge security service 131 may comprise a Secure Access Service Edge (SASE). In other examples, edge security service 131 may provide another type of edge-based service (e.g., content distribution). Data network 141 comprises an Application Server (AS) that hosts applications (e.g., media streaming applications, social media applications, IoT applications, online gaming applications, etc.) for user device 101. Data network 141 may be representative of a public data network (e.g., the Internet) or a private data network (e.g., an enterprise network).

User device 101 and access network 111 comprise antennas, amplifiers, filters, modulation, analog/digital interfaces, microprocessors, software, memories, transceivers, bus circuitry, and the like. User device 101, access network 111, core network 120, edge security service 131, and data network 141 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 100 as described herein.

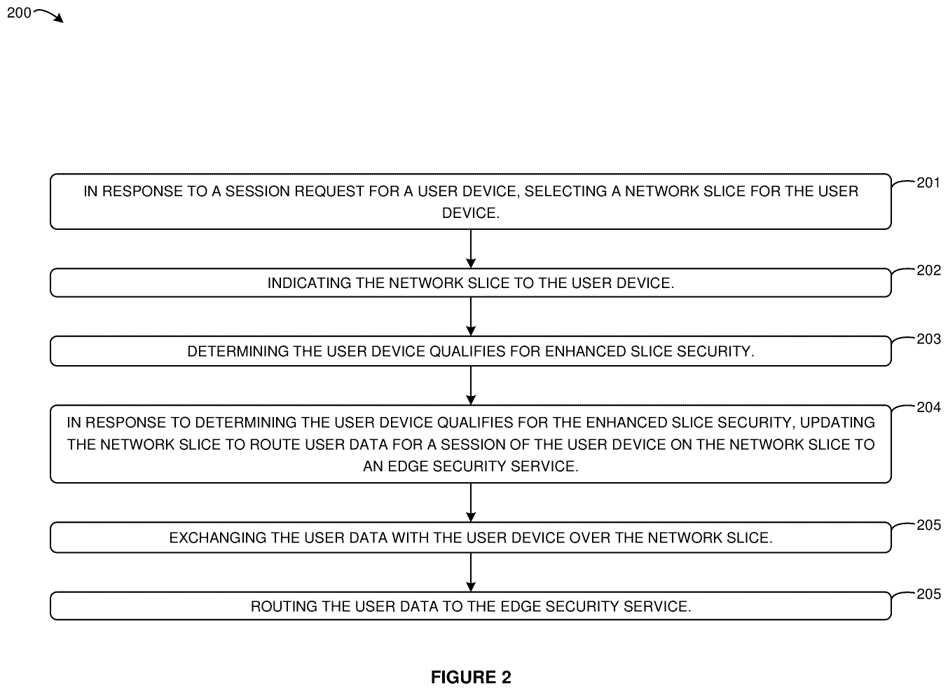

FIG. 2 illustrates process 200. Process 200 comprises an exemplary operation of communication network 100 to provide enhanced network slice security. The operation may vary in other examples. The operations of process 200 comprise, in response to a session request for a user device, selecting a network slice for the user device (step 201). The session request identifies the network slice. The operations further comprise indicating the network slice to the user device (step 202). The operations further comprise determining the user device qualifies for enhanced slice security (step 203). The operations further comprise, in response to determining the user device qualifies for the enhanced slice security, updating the network slice to route user data for a session of the user device on the network slice to an edge security service (step 204). The operations further comprise exchanging the user data with the user device over the network slice (step 205). The operations further comprise routing the user data to the edge security service (step 206). The edge security service enforces security policies on the user data and delivers the user data to a data network.

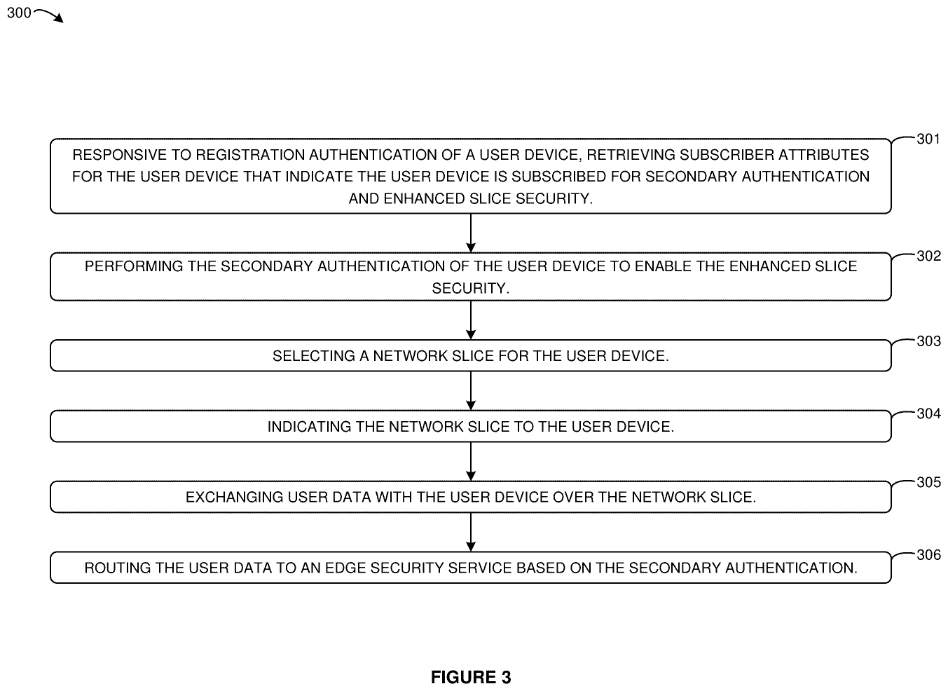

FIG. 3 illustrates process 300. Process 300 comprises an exemplary operation of communication network 100 to provide enhanced network slice security. Process 300 comprises an example of process 200 illustrated in FIG. 2, however process 200 may differ. The operation may vary in other examples. The operations of process 300 comprise, responsive to registration authentication of a user device, retrieving subscriber attributes for the user device that indicate the user device is subscribed for secondary authentication and enhanced slice security (step 301). The operations further comprise performing the secondary authentication of the user device to enable the enhanced slice security (step 302). The operations further comprise selecting a network slice for the user device (step 303). The operations further comprise indicating the network slice to the user device (step 304). The operations further comprise exchanging user data with the user device over the network slice (step 305). The operations further comprise routing the user data to an edge security service based on the secondary authentication (step 306). The edge security service applies security policies on the user data and delivers the user data to an enterprise network.

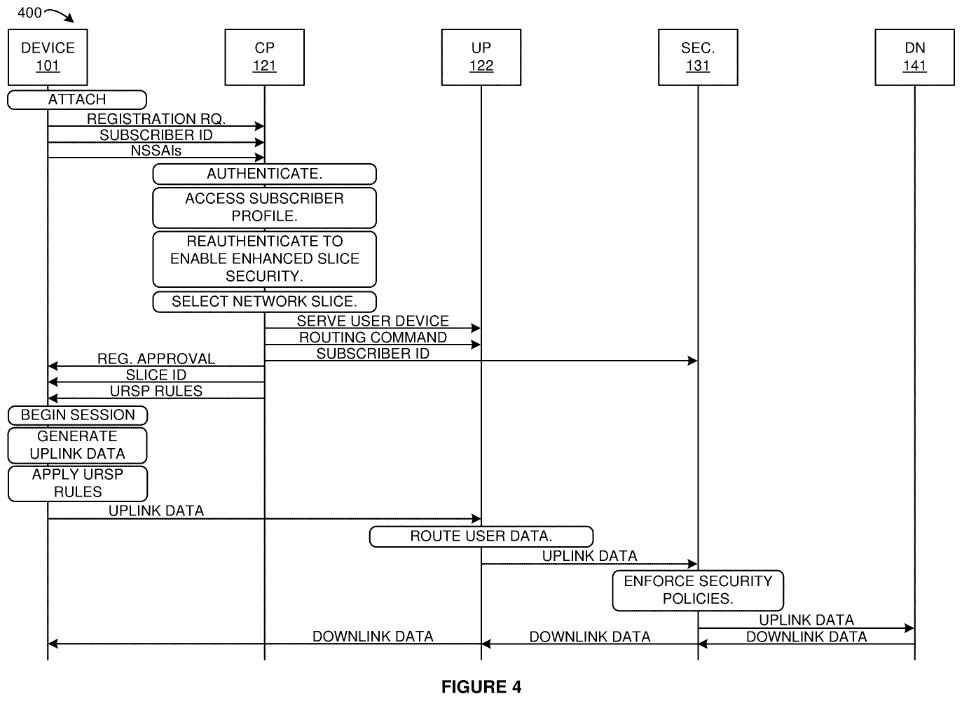

FIG. 4 illustrates process 400. Process 400 comprises an exemplary operation of wireless communication network 100 to provide enhanced network slice security. Process 400 comprises an example of processes 200 and 300 illustrated in FIGS. 2 and 3, however processes 200 and 300 may differ. The operation may vary in other examples. In some examples, user device 101 attaches to core network 120 over access network 111. User device 101 transfers a registration request (RQ.) to control plane (CP) 121. The registration request includes a subscriber Identifier (ID) that identifies user device 101 and Network Slice Selection Assistance Information (NSSAIs) that correspond to one or more of network slices 123. Exemplary subscriber IDs include Subscriber Concealed Identifier (SUCI), Subscriber Permanent Identifier (SUPI), International Mobile Subscriber Identifier (IMSI), International Mobile Equipment Identifier (IMEI), 5G-Global Unique Temporary Identifier (5G-GUTI), and the like. Control plane 121 authenticates the subscriber ID for user device 101 to verify user device 101's identity.

In response to authentication, control plane 121 accesses a subscriber profile for user device 101 stored by a network data system, such as a subscriber information database of the wireless communication network 100, to determine the subscribed services for user device 101. The subscriber profile comprises a set of subscriber attributes that indicate authorized service for user device 101. In this example, the subscriber attributes indicate user device 101 is subscribed for secondary authentication, enhanced slice security, and service on one or more of network slices 123. Control plane 121 initiates a secondary authentication procedure to enable enhanced slice security using edge security service 131. For example, control plane 121 may interface with an AAA server associated with edge security service 131 to reauthenticate the subscriber ID of user device 101 and authorize user device 101 for enhanced slice security over edge security service 131.

Responsive to secondary authentication, control plane 121 selects one or more of network slices 123 based on the NSSAIs indicated by user device 101 in the registration request. For example, control plane 121 may map a Single-NSSAI (S-NSSAI) received in the registration request to a network slice instance in core network 120. Control plane 121 directs user plane (UP) 122 to serve user device 101 over the selected one(s) of network slices 123. Since user device 101 is authorized for enhanced slice security, control plane 121 directs user plane 122 to route session traffic for user device 101 over the slice to edge security service (SEC.) 131. Control plane 121 forwards user device 101's subscriber ID and indicates the secondary authentication to edge security service 131. Edge security service 131 may select and apply security policies based on the subscriber ID, secondary authentication indication, and/or other information received from control plane 121 and/or user plane 122. Control plane 121 transfers a registration approval message to user device 101. The registration approval comprises data like the IP addresses, control plane ID, access network ID, bit rate, session setup information, selected network slices, and the like. Control plane 121 indicates the slice ID for the selected network slice, a PDU session start command, and User Equipment Route Selection Policy (URSP) rules to user device 101. The URSP rules drive user device 101 to route traffic over the selected slice for data sessions.

In response to the registration approval message, user device 101 begins a session over network 100 with data network 141. User device 101 generates and transfers uplink user data to the selected one(s) of network slices 123 over access network 111 based on the URSP rules. User plane 122 routes the uplink user data from the selected one(s) of network slices 123 to edge security service 131 based on the routing command from control plane 121. Edge security service 131 enforces security policies on the packet flow. For example, edge security service 131 may perform content filtering, session security, malware scanning, Domain Name System (DNS) filtering, firewall, intrusion detection and the like. Edge security service 131 transfers the uplink user data to data network (DN) 141. Data network 141 generates downlink user data for the session and transfers the user data to the selected one(s) of network slices 123 over edge security service 131. Edge security service 131 may apply security policies to the downlink packet flow. User plane 122 routes the user data from the selected one(s) of network slices 123 to user device 101 over access network 111.

While the above example triggers enhanced slice security for user device 101 based on subscriber attributes associated with user device 101, in some examples, enhanced slice security may be triggered based on other or additional factors. For example, control plane 121 may trigger enhanced slice security for user device 101 based on factors like geographic location, application type, PDU session type, device type, TAI, device capabilities, slice type, and/or other security relevant factors. In doing so, control plane 121 may ensure user device 101 receives enhanced slice security even when user device 101 is not subscribed for enhanced slice security. For example, user device 101 may move to a sensitive geographic location (e.g., a government facility, military installation, etc.) and control plane 121 may trigger enhanced slice security for user device 101 as described above while user device 101 is resident in the sensitive geographic location. Control plane 121 may maintain a correlation table, geotagged map, or some other type of data structure to determine when to trigger condition-based slice security enhancement.

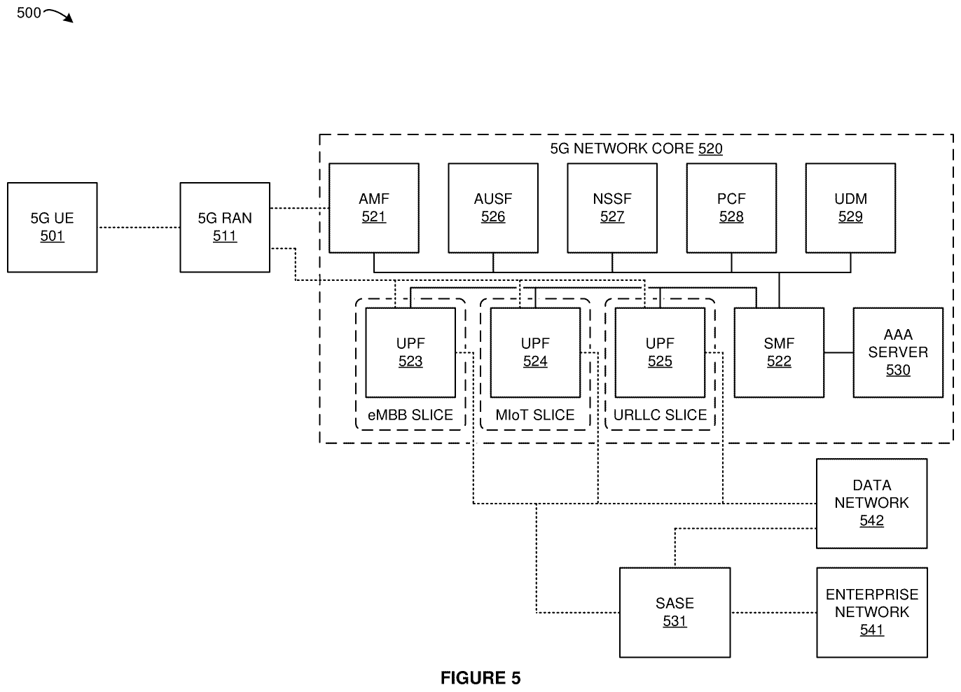

FIG. 5 illustrates 5G communication network 500 to provide enhanced network slice security. 5G communication network 500 comprises an example of communication network 100 illustrated in FIG. 1, however network 100 may differ. 5G communication network 500 comprises 5G User Equipment (UE) 501, 5G RAN 511, 5G network core 520, SASE 531, enterprise network 541, and data network 542. 5G network core 520 comprises AMF 521, SMF 522, UPFs 523-525, AUSF 526, NSSF 527, PCF 528, UDM 529, and AAA server 530. Other network functions and network entities like Unified Data Registry (UDR), Home Subscriber Register (HLR), Network Repository Function (NRF), Short Message Service Function (SMSF), Network Exposure Function (NEF), Application Function (AF), Equipment Identity Register (EIR), and Session Communication Proxy (SCP) are typically present in 5G network core 520 but are omitted for clarity. In other examples, 5G communication network 500 may comprise different or additional elements than those illustrated in FIG. 5.

In some examples, UE 501 wirelessly attaches to 5G RAN 511 over a 5GNR link. UE 501 is a wireless user device associated with enterprise network 541. UE 501 undergoes a Random Access Channel (RACH) procedure with 5G RAN 511 to establish a secure signaling channel. UE 501 transfers a registration request to AMF 521 over 5G RAN 511. The registration request indicates a registration type, 5G-GUTI, Tracking Area Identifier (TAI), NSSAI requests, UE capabilities, requests for PDU sessions with enterprise network 541 and/or data network 542, and the like. In response to the registration request, AMF 521 transfers a Non-Access Stratum (NAS) identity request to UE 501 over a NAS signaling link between UE 501 and AMF 521 that traverses 5G RAN 511. UE 501 indicates its SUCI to AMF 521 over the NAS link that traverses 5G RAN 511. AMF 521 transfers an authentication request to AUSF 526 to retrieve authentication vectors to authenticate UE 501. The request comprises the SUCI for UE 501. AUSF 526 indicates the SUCI and requests authentication vectors from UDM 529. UDM 529 accesses the subscriber profile for UE 501 and derives the SUPI for UE 501 based on the SUCI. The SUPI comprises the IMSI associated with the Subscriber Identity Module (SIM) card for UE 501. UDM 529 generates authentication vectors for UE 501. UDM 529 returns the vectors and SUPI to AUSF 526. The authentication vectors comprise a random number, expected result, key selection criteria, and the like. AUSF 526 forwards the SUPI and authentication vectors to AMF 521. AMF 521 transfers an authentication challenge that comprises the random number and key selection criteria to UE 501 over the NAS link that traverses 5G RAN 511. UE 501 hashes random number with its secret key to generate an authentication result and indicates the authentication result to AMF 521 over the NAS link. AMF 521 matches the expected result retrieved from AUSF 526 with the authentication result received from UE 501 to authenticate UE 501.

Responsive to the authentication, AMF 521 transfers a context registration request to UDM 529 that includes AMF ID, a supported feature list, a Permanent Equipment Identifier (PEI) for UE 501, and the like. UDM 529 indicates successful UDM registration to AMF 521. In response, AMF 521 requests access and mobility subscription data, SMS selection subscription data, and UE context in SMF data from UDM 529. UDM 529 accesses the subscriber profile for UE 501 and returns the requested data. The access and mobility subscription data comprises a supported feature list for UE 501 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. The access and mobility subscription data, SMS selection subscription data, and/or UE context in SMF data indicates UE 501 is subscribed for secondary authentication with AAA server 530 and enhanced slice security via SASE 531. For example, the SUPI of UE 501 may comprise a network specific identity code associated with enterprise network 541. AMF 521 forms the UE context for UE 501 using the retrieved information. The UE context defines the authorized services for UE 501.

In some examples, enhanced slice security is triggered for UE 501 based on other or additional factors besides subscriber attributes retrieved from UDM 529. For example, AMF 521 may trigger enhanced slice security for UE 501 based on factors like geographic location, application type, PDU session type, device type, TAI, UE capabilities, slice type, and/or other security relevant factors. In doing so, AMF 521 may ensure UEs receive enhanced slice security even when they are not subscribed for enhanced slice security. For example, UE 501 may request a PDU session for a sensitive application type (e.g., an online banking application, a medical/health monitoring application, etc.) and AMF 521 may enhance slice security for UE 501's PDU sessions for sensitive application types and avoid enhancing slice security for UE 501's PDU session for non-sensitive application types. AMF 521 may maintain a correlation table, geotagged map, or some other type of data structure to determine when to trigger condition-based slice security enhancement.

AMF 521 may interface with NSSF 527 to select one or more network slices for UE 501 based on the slice selection information, S-NSSAIs requested by UE 501, and the allowed S-NSSAIs. Wireless network slices typically comprise collections of core network and RAN resources that have capabilities to provide service types (e.g., low-latency service) to UEs. In this example, 5G network core 520 comprises an eMBB slice, an MIoT slice, and a URLLC slice. UPF 523 forms the eMBB slice, UPF 524 forms the MIoT slice, and UPF 525 forms the URLLC slice. Although illustrated as only comprising UPFs, the eMBB slice, MIoT slice, and URLLC may comprise other network elements in 5G communication network 500. Moreover, some elements may be shared between different ones of the network slices. For example, the eMBB slice and the MIoT slice may both comprise SMF 522. It should be appreciated that 5G communication network 500 typically comprises many more network slices and slice types and that three distinct slices are shown for clarity.

AMF 521 selects NSSF 527 to initiate network slice selection for UE 501. For example, AMF 521 may interface with an NRF to locate NSSF 527 in 5G network core 520. AMF 521 transfers a network slice selection get request to NSSF 527. The request indicates the list of allowed S-NSSAIs for UE 501 retrieved from UDM 529, the S-NSSAIs requested by UE 501 received in the registration request, and/or other slice selection information. NSSF 527 maps ones of the requested S-NSSAIs that correspond to the allowed S-NSSAIs to network slice instances in 5G network core 520. For example, NSSF 527 may map a requested and allowed S-NSSAI to the URLLC slice formed by UPF 525. NSSF 527 returns slide IDs for the mapped network slice instances to AMF 521. NSSF 527 may also return a list of SMFs that can support the mapped network slices.

AMF 521 transfers a policy creation request to PCF 528 to create a policy association for UE 501. PCF 528 responds to the request with policy association information like the SUPI, GPSI, PEI, and user location information for UE 501. The policy association information includes URSP rules that drive UE 501 to route user data for its sessions to ones of UPFs 523-525 that compose its selected network slices. PCF 528 subscribes to AMF 521 for event reporting like user location updates, registration state changes, communication failure events, and the like. AMF 521 creates a PCF subscription based on the policy association information and signals PCF 528 of the successful subscription creation.

AMF 521 selects SMF 522 to serve UE 501 based on SMF selection data received from UDM 529, the network policies received from PCF 528, and/or the network slice(s) selected by NSSF 527. AMF 521 transfers a list of requested PDU sessions with enterprise network 541 and/or data network 542 (as received during the registration request), a PDU session activation command, and the SUPI (that includes UE 501's IMSI) to SMF 522. AMF 521 indicates that UE 501 is subscribed for secondary authentication and enhanced slice security using SASE 531.

SMF 522 receives the PDU session list, session activation command, and the SUPI from AMF 521. SMF 522 selects one or more of UPFs 523-525 to support the PDU sessions based on the selected network slices. SMF 522 initiates secondary authentication with AAA server 530 based on the indication from AMF 521. AAA server 530 is representative of a network entity associated with enterprise network 541 to authenticate and authorize PDU sessions with enterprise network 541. Although illustrated as being located in 5G network core 520, in some examples AAA server 530 may instead be located in enterprise network 541. When located in enterprise network 541, SMF 522 may communicate with AAA server 530 over UPF 523 and an AAA server proxy. When located in network core 520 (as illustrated in FIG. 5), SMF 522 may communicate with AAA server 530 directly. AAA server 530 operates similarly whether located in network core 520 or enterprise network 541.

SMF 522 transfers a secondary authentication request to AAA server 530. The request indicates the IMSI for UE 501. AAA server 530 maintains a registry that associates IMSIs for devices associated with enterprise network 541 with device MSISDNs authorized for services on enterprise network 541. AAA server 530 receives the request and correlates the IMSI with one of the MSISDNs to authenticate and authorize UE 501 for a PDU session with enterprise network 541. AAA server 530 transfers an authorization message for UE 501's PDU session with enterprise network 541 to SMF 522. The authorization message comprises the MSISDN for UE 501, a PDU session authorization, and data like policy and charging information, list of allowed Media Access Control (MAC) addresses, list of allowed Virtual Local Area Network (VLAN) tags, authorized session Aggregate Maximum Bit Rate (AMBR), routing information, and the like.

SMF 522 receives the authorization message from AAA server 530. SMF 522 allocates IP addresses to UE 501 for the requested PDU sessions and allocates Tunnel End Point ID (TEID) for the session. SMF 522 transfers a session modification request that includes a session endpoint identifier, IP address, MSISDN, session start/stop information, and TEID to the selected ones of UPFs 523-525 to setup the PDU session(s) for UE 501. SMF 522 directs the selected ones of UPFs 523-525 to route packets for UE 501's PDU sessions to SASE 531 based on the authorization message from AAA server 530. Conversely, UPFs 523-525 do not route packets for PDU sessions that are not authorized by AAA server 530 for enhanced slice security to SASE 531. As such, UPFs 523-525 may selectively apply enhanced slice security to authorized PDU sessions and avoid providing enhanced slice security to unauthorized PDU sessions.

Conventional 5G communication networks typically comprise a standalone security slice. These security slices create a dedicated virtual network segment for security services. However, the security slices typically lack the functionality of other slice types (e.g., low-latency functionality provided by a URLLC slice) while the other slice types typically lack the security functionality of the security slices. For example, a UE may be unable to create a desired data session (e.g., a low-latency data session) over a security slice. Consequently, the user must either sacrifice session performance or session security. This tradeoff degrades the user experience. Advantageously, by controlling UPFs 523-525 to route user data for authorized PDU sessions to SASE 531, 5G communication network 500 reduces the tradeoff between slice security and slice capability to allow users to receive both desired session performance and desired session security thereby improving the user experience.

Returning to the present example, the selected ones of UPFs 523-525 set up a default bearer for UE 501 that traverses 5G RAN 511. The default bearer is a link to carry IP packets for UE 501's PDU session(s). The selected ones of UPFs 523-525 transfer accounting message(s) to SASE 531 to enable enhanced slice security for UE 501. The accounting message includes the IMSI, MSISDN, session start data, session end data, and the like. SASE 531 selects and enables security policies based on the accounting message(s). For example, SASE 531 may host a data structure that associates UE IMSIs/MSISDNs with security policies, input UE 501's IMSI/MSISDN into the data structure, and select firewalls, intrusion detection, and intrusion prevention policies for the PDU session(s) based on the output from the data structure.

SMF 522 notifies AMF 521 that the default bearer is set up. In response, AMF 521 registers UE 501 for service on network 500. AMF 521 generates a registration accept message that includes the URSP rules, the allocated IP address for UE 501, RAN ID, AMBR, Globally Unique AMF ID (GUAMI), PDU session data, S-NSSAI list, security data, and the like. AMF 521 transfers the registration accept message to UE 501 over the NAS link that traverses 5G RAN 511. UE 501 receives the registration accept message and launches a user application to begin the PDU session(s) with enterprise network 541. The application generates uplink data and UE 501 wirelessly transfers the uplink data for the PDU session to the selected ones of UPFs 523-525 over the default bearer that traverses 5G RAN 511 based on the URSP rules provided by PCF 528. Since the PDU session(s) of UE 501 are authorized by AAA server 530 for enhanced slice security, the selected ones of UPFs 523-525 route the uplink data to SASE 531. For example, the selected ones of UPFs 523-525 may route the uplink data to a security gateway communicatively coupled to SASE 531 based on information like Data Network Name (DNN). UPFs 523-525 avoid routing data for unauthorized PDU sessions to SASE 531 (e.g., instead route to data network 542).

SASE 531 receives the uplink data and enforces the selected security policies on the uplink data. For example, SASE 531 may perform content filtering, session security, malware scanning, DNS filtering, firewall, intrusion detection and prevention, and the like on the PDU session. SASE 531 forwards the uplink data after enforcement of the security policies to enterprise network 541. Enterprise network 541 generates and transfers downlink data for the PDU session to SASE 531. SASE 531 enforces the security policies on the downlink data and forwards the secure downlink data to the selected ones of UPFs 523-525. The selected ones UPFs 523-525 route the downlink data to UE 501 over the default bearer that traverses 5G RAN 511.

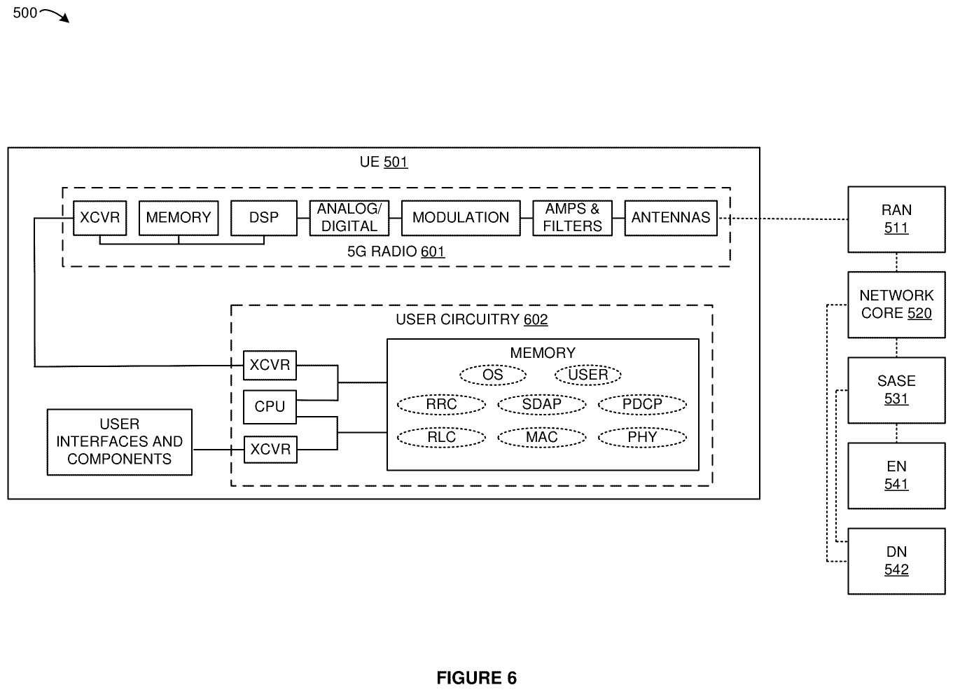

FIG. 6 illustrates UE 501 in 5G communication network 500. UE 501 comprises an example of user device 101 illustrated in FIG. 1, although user device 101 may differ. UE 501 comprises 5G radio 601 and user circuitry 602. 5G Radio 601 comprises 5GNR antennas, amplifiers, filters, modulation, analog-to-digital interfaces, Digital Signal Processers (DSP), memory, and transceivers (XCVRs) that are coupled over bus circuitry. User circuitry 602 comprises memory, CPU, user interfaces and components, and transceivers that are coupled over bus circuitry.

The memory in user circuitry 602 stores an operating system (OS), user applications, and 5GNR network applications for PHY, MAC, RLC, PDCP, SDAP, and RRC. The antenna in 5G radio 601 is wirelessly coupled to 5G RAN 511 over a 5GNR link. Transceivers in radio 601 are coupled to a transceiver in user circuitry 602. A transceiver in user circuitry 602 is typically coupled to user interfaces and components like displays, controllers, and memory.

In 5G radio 601, the antennas receive wireless signals from 5G RAN 511 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 602 over the transceivers. In user circuitry 602, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 601, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 511 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

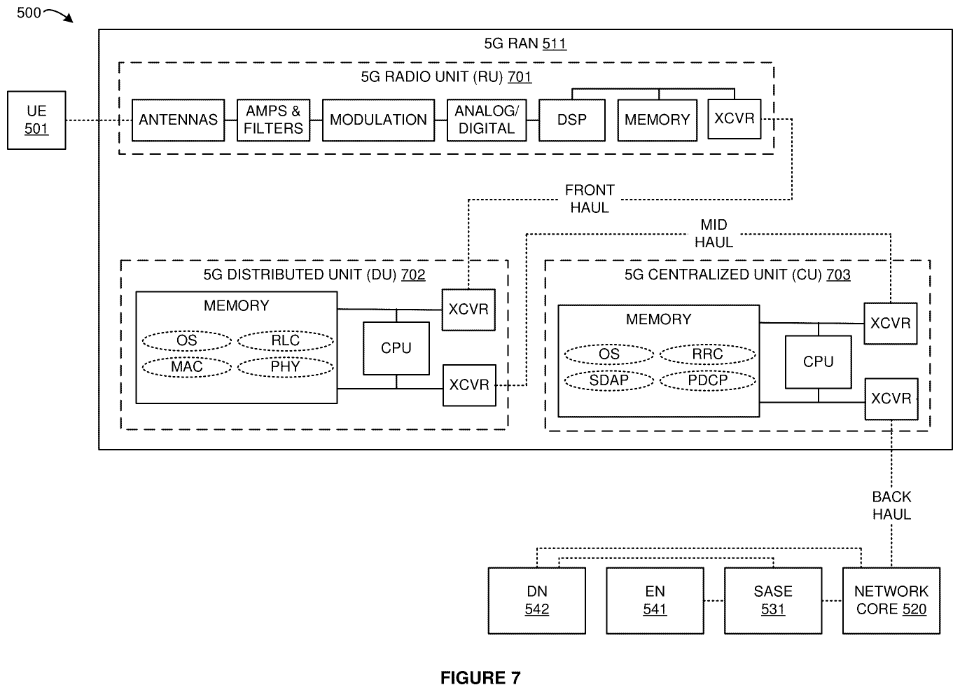

FIG. 7 illustrates 5G RAN 511 in 5G communication network 500. 5G RAN 511 comprises an example of the access network 111 illustrated in FIG. 1, although access network 111 may differ. RU 701 comprises 5GNR antennas, amplifiers, filters, modulation, analog-to-digital interfaces, DSP, memory, and transceivers (XCVRs) that are coupled over bus circuitry. UE 501 is wirelessly coupled to antennas in 5G RU 701 over 5GNR links. Transceivers in 5G RU 701 are coupled to transceivers in DU 702 over fronthaul links like enhanced Common Public Radio Interface (eCPRI). The DSPs in RU 701 executes their operating systems and radio applications to exchange 5GNR signals with UE 501 and to exchange 5GNR data with DU 702.

For the uplink, the antennas in RU 701 receive wireless signals from UE 501 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 702 over the transceivers.

For the downlink, the DSPs receive downlink 5GNR symbols from DU 702. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 501 that transport the downlink 5GNR signaling and data.

DU 702 comprises memory, CPU, and transceivers that are coupled over bus circuitry. The memory in DU 702 stores operating systems and 5GNR network applications like PHY, MAC, and RLC. CU 703 comprises memory, CPU, and transceivers that are coupled over bus circuitry. The memory in CU 703 stores an operating system and 5GNR network applications like PDCP, SDAP, and RRC. Transceivers in DU 702 are coupled to transceivers in RU 701 over front-haul links. Transceivers in DU 702 are coupled to transceivers in CU 703 over mid-haul links. A transceiver in CU 703 is coupled to network core 520 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/dc-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

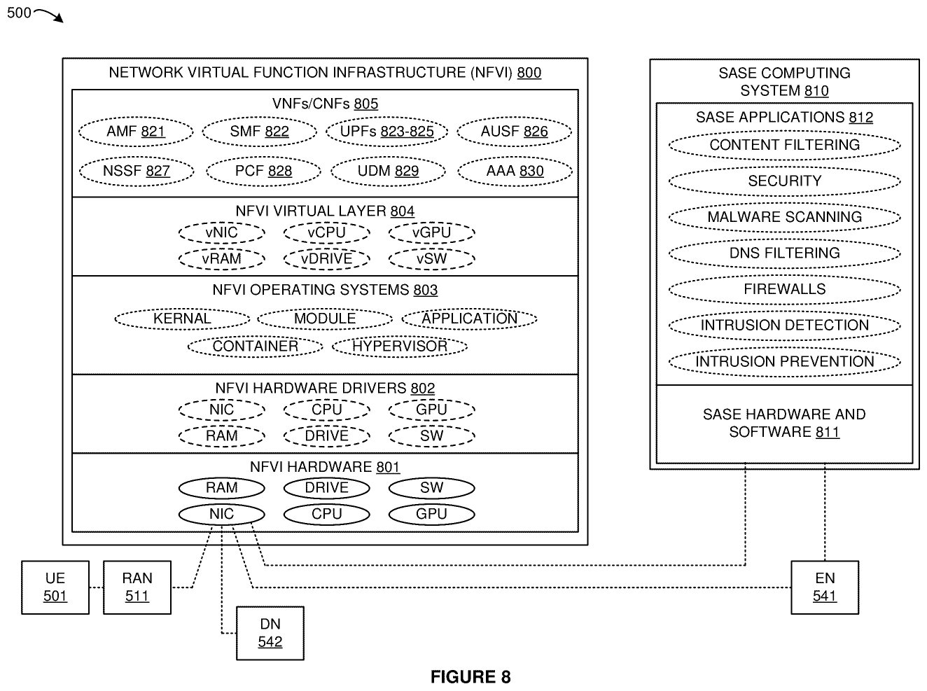

FIG. 8 illustrates Network Function Virtualization Infrastructure (NFVI) 800 and SASE computing system 810 in 5G wireless communication network 500. NFVI 800 comprises an example of core network 120 illustrated in FIG. 1, although core network 120 may differ. NFVI 800 comprises NFVI hardware 801, NFVI hardware drivers 802, NFVI operating systems 803, NFVI virtual layer 804, and NFVI Virtual Network Functions (VNFs)/Cloud-Native Network Functions (CNFs) 805. NFVI hardware 801 comprises Network Interface Cards (NICs), CPU, GPU, RAM, Flash/Disk Drives (DRIVE), and Data Switches (SW). NFVI hardware drivers 802 comprise software that is resident in the NIC, CPU, GPU, RAM, DRIVE, and SW. NFVI operating systems 803 comprise kernels, modules, applications, containers, hypervisors, and the like. NFVI virtual layer 804 comprises vNIC, vCPU, vGPU, vRAM, vDRIVE, and vSW. NFVI VNFs/CNFs 805 comprise AMF 821, SMF 822, UPFs 823-825, AUSF 826, NSSF 827, PCF 828, UDM 829, and AAA 830. Additional VNFs/CNFs like UDR, HLR, NRF, SMSF, NEF, AF, EIR, and SCP are typically present but are omitted for clarity.

SASE computing system 810 comprises an example of edge security service 131 illustrated in FIG. 1, although edge security service 131 may differ. SASE computing system 810 comprises SASE hardware and software 811 and SASE applications 812. SASE hardware and software 811 comprises NICs, CPU, GPU, RAM, DRIVE, and SW and hardware drivers resident in the NIC, CPU, GPU, RAM, DRIVE, and SW. SASE hardware and software 811 comprises operating systems like kernels, modules, applications, containers, and hypervisors as well as a virtual layer that comprises vNIC, vCPU, vGPU, vRAM, vDRIVE, and vSW. SASE applications 812 comprise applications for content filtering, security, malware scanning, DNS filtering, firewalls, intrusion detection, and intrusion prevention. Additional SASE applications are typically present but are omitted for clarity.

SASE computing system 810 comprises a unified, cloud-native approach to security, merging multiple functions into a single service, which contrasts with the fragmented nature of traditional network routing and security architectures. SASE computing system 810 ensures real-time, context aware policy enforcement, securing user and device traffic and enhancing user experience when compared to other security solutions. SASE computing system 810's inherent flexibility, cost efficiency, and zero trust architecture surpasses the capabilities of traditional firewalls or VPNs, making it appropriate for expanded business needs. By consolidating security functions for end-users, remote IoT devices, branches and offices, SASE computing system 810 not only simplifies the security landscape but also future-proofs organizations against evolving challenges.

SASE computing system 810 combines network security functions with WAN capabilities to support organizations' dynamic, secure access needs. SASE computing system 810 may support security features like Zero Trust Network Access (ZTNA), Secure Web Gateways (SWG), Cloud Access Security Brokers (CASB), and Firewall as a Service (FWaaS), among others. This integrated approach allows organizations to provide secure and optimized connectivity to cloud services, applications, and resources from any location or device. SASE computing system 810 decentralizes the security and networking architecture, ensuring remote and mobile users can connect directly to their destinations without being routed through a centralized data center. This eliminates the need for backhauling, which traditionally rerouted traffic through a central point to access internal applications and apply security, increasing latency from the added transport distance. With SASE computing system 810, users experience faster and more efficient connectivity, remaining as local as possible, enhancing productivity and user experience.

NFVI 800 and SASE computing system 810 may be co-located, each located at a single site, or be distributed across multiple geographic locations. The NIC in NFVI hardware 801 is coupled to 5G RAN 511, the NIC in SASE hardware and software 811, data network 542, and to external systems (not illustrated). The NIC in SASE hardware and software 811 is coupled to the NIC in NFVI hardware 801 and to enterprise network 541. The link between NFVI 800 and SASE computing system 810 may comprise a direct connection or an indirect connection. NFVI hardware 801 executes NFVI hardware drivers 802, NFVI operating systems 803, NFVI virtual layer 804, and NFVI VNFs/CNFs 805 to form AMF 521, SMF 522, UPFs 523-525, AUSF 526, NSSF 527, PCF 528, UDM 529, and AAA 530. The hardware in SASE hardware and software and software 811 executes the hardware drives, operating systems, virtual layer, and SASE applications 812 to form the SASE applications illustrated in FIG. 8.

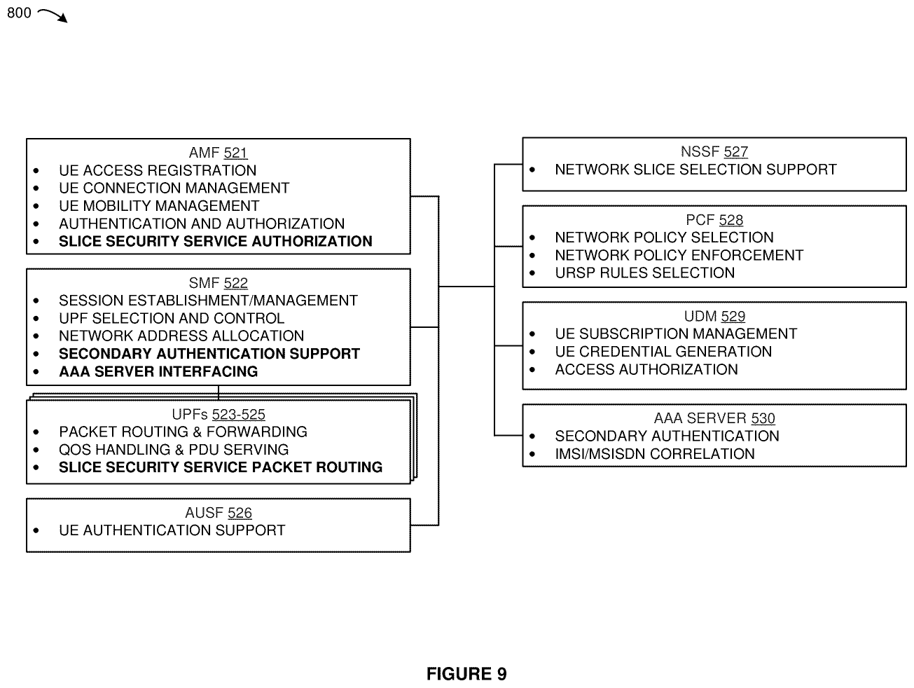

FIG. 9 further illustrates NFVI 800 in 5G communication network 500. AMF 521 comprises capabilities for UE registration, UE connection management, UE mobility management, authentication, authorization, and slice security service authorization. SMF 522 comprises capabilities for session establishment, session management, UPF selection, UPF control, network address allocation, secondary authentication support, and AAA server interfacing. UPFs 523-525 comprises capabilities for packet routing, packet forwarding, QoS handling, PDU serving, and slice security service packet routing. AUSF 526 comprises capabilities for UE authentication support. NSSF 527 comprises capabilities for network slice selection support. PCF 528 comprises capabilities for network policy selection, network policy enforcement, and URSP rules selection. UDM 529 comprises capabilities for UE subscription management, UE credential generation, and access authorization. AAA server 530 comprises capabilities for secondary authentication and IMSI/MSISDN correlation.

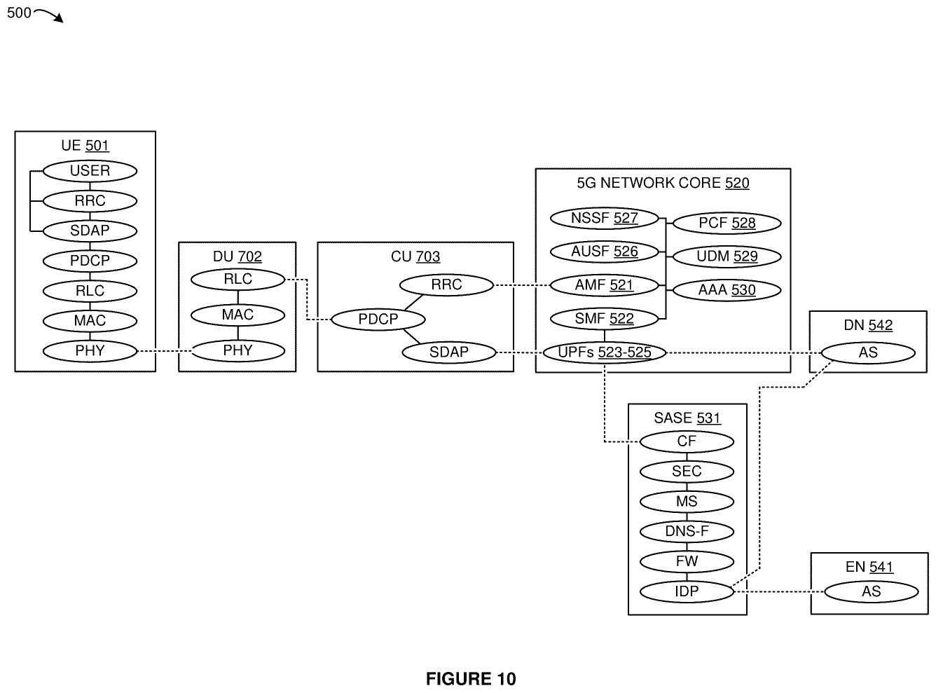

FIG. 10 illustrates an exemplary operation of 5G communication network 500 to provide enhanced network slice security. The exemplary operation comprises an example of processes 200, 300, and 400 illustrated in FIGS. 2-4, however processes 200, 300, and 400 may differ. The exemplary operation may vary in other examples. In some examples, UE 501 wirelessly attaches to 5G RAN 511. The RRC in UE 501 transfers a registration request to the RRC in CU 703 over the PDCPs, RLCs, MACs, and PHYs. The RRC in CU 703 forwards the registration request to AMF 521 over 5G RAN 511. AMF 521 interfaces with UE 501, AUSF 526, and UDM 529 to authenticate UE 501. Responsive to the authentication, AMF 521 registers with UDM 529 for context generation. AMF 521 retrieves access and mobility subscription data, SMS selection subscription data, and UE context in SMF data from UDM 529. UDM 529 accesses the subscriber profile for UE 501 and returns the requested data. The retrieved data indicates UE 501 is subscribed for secondary authentication with AAA server 530 and enhanced slice security via SASE 531. AMF 521 forms the UE context for UE 501 using the retrieved information.

AMF 521 interfaces with NSSF 527 to select network slices for UE 501. NSSF 527 compares S-NSSAIs requested by UE 501 to allowed S-NSSAIs and discards ones of the requested S-NSSAIs that do not correspond to an allowed S-NSSAI. NSSF 527 maps the remining requested S-NSSAIs to network slice instances in 5G network core 520. In this example, NSSF 527 maps the S-NSSAIs to the eMBB slice and the URLLC slice. NSSF 527 returns slide IDs for the eMBB slice and the URLLC slice to AMF 521. AMF 521 indicates the slice IDs to PCF 528 which returns URSP rules that drive UE 501 to route data for the PDU sessions to UPFs 523 and 525. AMF 521 selects SMF 522 to serve UE 501 and transfers a list of requested PDU sessions with enterprise network 541, a PDU session activation command, and the SUPI (that includes UE 501's IMSI) to SMF 522. AMF 521 indicates that UE 501 is subscribed for secondary authentication and enhanced slice security using SASE 531 to SMF 522.

SMF 522 selects UPFs 523 and 525 to support the PDU sessions based on the slice IDs for the selected slices. SMF 522 initiates secondary authentication with AAA server 530 and indicates the IMSI of UE 501 to AAA server 530. AAA server 530 authorizes UE 501 for a PDU session with enterprise network 541 over SASE 531 based on the IMSI of UE 501. AAA server 530 transfers an authorization message for UE 501's PDU session with enterprise network 541 to SMF 522. SMF 522 allocates IP addresses and a TEID for the session. SMF 522 directs the UPFs 523 and 525 to serve UE 501 and to route packets for UE 501's PDU sessions to SASE 531 based on the authorization message from AAA server 530. UPFs 523 and 525 establish default bearers to support the PDU sessions and transfer accounting message(s) to SASE 531 to enable enhanced slice security for UE 501. SASE 531 selects security policies for UE 501.

SMF 522 notifies AMF 521 that the PDU sessions are ready to begin. AMF 521 registers UE 501 for service on network 500. AMF 521 generates and transfers a registration accept message for UE 501 to the RRC in CU 703. The registration accept message includes the UE context, URSP rules, and/or other data for UE 501 to use to begin its PDU sessions. The RRC forwards the registration accept message to the RRC in UE 501 over the PDCPs, RLCs, MACs, and PHYs. The RRC in UE 501 receives the registration accept message. The user interface and components of UE 501 receive a user input that launches a user application to begin the PDU session(s) with enterprise network 541. The application generates uplink data for the PDU sessions. The RRC directs the SDAP in UE 501 to transfer the uplink data for the PDU session to UPFs 523 and 525 based on the URSP rules. The SDAP transfers the uplink data to the SDAP in CU 703 over the PDCPs, RLCs, MACs, and PHYs. The SDAP in CU 703 forwards the uplink data to UPFs 523 and 525.

UPFs 523 and 525 (i.e., the eMBB slice and the URLLC slice) route the uplink data to SASE 531 based on the authorization from AAA server 530. The content filtering application (CF), security application (SEC), malware scanning application (MS), DNS filtering application (DNS-F), firewall application (FW), and instruction detection and prevention application (IDP) in SASE 531 receive the uplink data and enforce the selected security policies on the uplink data. SASE 531 forwards the secure uplink data to enterprise network 541. Enterprise network 541 generates and transfers downlink data for the PDU sessions to SASE 531. The content filtering application, security application, malware scanning application, DNS filtering application, firewall application, and instruction detection and prevention application in SASE 531 enforce security policies on the downlink data. SASE 531 forwards the secure downlink data to UPFs 523 and 525. UPFs 523 and 525 route the downlink data to the SDAP in CU 703. The SDAP transfers the downlink data to the SDAP in UE 501 over the PDCPs, RLCs, MACs, and PHYs.

The wireless data network circuitry described above comprises computer hardware and software that form special-purpose network circuitry to provide enhanced network slice security. The computer hardware comprises processing circuitry like CPUs, DSPs, GPUS, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to provide enhanced network slice security.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
in response to a session request for a user device, selecting a network slice for the user device wherein the session request identifies the network slice;
indicating the network slice to the user device;
determining the user device qualifies for enhanced slice security;
in response to determining the user device qualifies for the enhanced slice security, updating the network slice to route user data for a session of the user device on the network slice to an edge security service;
exchanging the user data with the user device over the network slice; and
routing the user data to the edge security service wherein the edge security service enforces security policies on the user data and delivers the user data to a data network.

2. The method of claim 1 further comprising:
exchanging other user data with other user devices that do not qualify for the enhanced slice security over the network slice; and
routing the other user data to the data network without routing the other user data to the edge security service.

3. The method of claim 1 wherein:
wherein selecting the network slice for the wireless user device comprises mapping a Single-Network Slice Selection Assistance Information (S-NSSAI) indicated by the user device in the session request to a network slice instance; and
determining when the user device qualifies for the enhanced slice security comprises accessing a subscriber profile for the user device and identifying a subscriber attribute that indicates the user device qualifies for the enhanced slice security.

4. The method of claim 1 wherein indicating the network slice to the user device comprises directing the user device to begin a Protocol Data Unit (PDU) session over the network slice and indicating a User Equipment Route Selection Policy (URSP) rule to the user device that directs the user device to route the user data to the network slice.

5. The method of claim 1 wherein routing the user data to the edge security service when the user device qualifies for the enhanced slice security comprises routing the user data to a Secure Access Service Edge (SASE) that enforces the security policies on the user data and delivers the user data to the data network.

6. The method of claim 1 wherein the network slices comprise at least one of an Ultra-Reliable Low-Latency Communications (URLLC) slice, a Massive Internet-of-Things (MIoT) slice, an Enhanced Mobile Broadband (eMBB) slice, or a Vehicle-to-Anything (V2X) slice.

7. The method of claim 1 wherein the security policies comprise one or more of content filtering, security features, malware scanning, Domain Name Service (DNS) filtering, firewalls, intrusion detection, or intrusion prevention.

8. A communication network comprising:
a control plane configured to:
in response to a session request for a user device, select a network slice for the user device wherein the session request identifies the network slice;
indicate the network slice to the user device;
determine the user device qualifies for enhanced slice security; and
in response to determining the user device qualifies for the enhanced slice security, update the network slice to route user data for a session of the user device on the network slice to an edge security service; and
a user plane configured to:
exchange the user data with the user device over the network slice; and
route the user data to the edge security service wherein the edge security service enforces security policies on the user data and delivers the user data to a data network.

9. The communication network of claim 8 wherein the user plane is further configured to:
exchange other user data with other user devices that do not qualify for the enhanced slice security over the network slice; and
route the other user data to the data network without routing the other user data to the edge security service.

10. The communication network of claim 8 wherein the control plane is configured to:
map a Single-Network Slice Selection Assistance Information (S-NSSAI) indicated by the user device in the session request to a network slice instance to select the network slice for the wireless user device; and
access a subscriber profile for the user device and identify a subscriber attribute that indicates the user device qualifies for the enhanced slice security to determine when the user device qualifies for the enhanced slice security.

11. The communication network of claim 8 wherein the user plane is configured to direct the user device to begin a Protocol Data Unit (PDU) session over the network slice and indicate a User Equipment Route Selection Policy (URSP) rule that to the user device that directs the user device to route the user data to the network slice to indicate the network slice to the user device.

12. The communication network of claim 8 wherein the user plane is configured to route the user data to a Secure Access Service Edge (SASE) that enforces the security policies on the user data and delivers the user data to the data network to route the user data to the edge security service when the user device qualifies for the enhanced slice security.

13. The communication network of claim 8 wherein:
the network slices comprise at least one of an Ultra-Reliable Low-Latency Communications (URLLC) slice, a Massive Internet-of-Things (MIoT) slice, an Enhanced Mobile Broadband (eMBB) slice, or a Vehicle-to-Anything (V2X) slice; and
the security policies comprise one or more of content filtering, security features, malware scanning, Domain Name Service (DNS) filtering, firewalls, intrusion detection, or intrusion prevention.

14. The communication network of claim 8 further comprising a Network Function Virtualization Infrastructure (NFVI) configured to execute the control plane and the user plane; and wherein:
the control plane comprises one or more of an Access and Mobility Management Function (AMF), a Session Management Function (SMF), a Network Slice Selection Function (NSSF), a Policy Control Function (PCF), a Unified Data Management (UDM), or an Authentication, Authorization, and Accounting (AAA) server; and
the user plane comprises a User Plane Function (UPF).

15. One or more non-transitory computer readable storage media having program instructions stored thereon, wherein the program instruction, when executed by a computing system, direct the computing system to perform operations, the operations comprising:
responsive to registration authentication of a user device, retrieving subscriber attributes for the user device that indicate the user device is subscribed for secondary authentication and enhanced slice security;
performing the secondary authentication of the user device to enable the enhanced slice security;
selecting a network slice for the user device;
indicating the network slice to the user device;
exchanging user data with the user device over the network slice; and
routing the user data to an edge security service based on the secondary authentication wherein the edge security service enforces security policies on the user data and delivers the user data to an enterprise network.

16. The computer readable storage media of claim 15 wherein selecting the network slice for the wireless user device comprises mapping a Single-Network Slice Selection Assistance Information (S-NSSAI) requested by the user device to a network slice instance.

17. The computer readable storage media of claim 15 wherein retrieving the subscriber attributes for the user device that indicate the user device is subscribed for the secondary authentication and the enhanced slice security comprises accessing a subscriber profile for the user device and retrieving the subscriber attributes that indicate the user device is subscribed for the secondary authentication and the enhanced slice security.

18. The computer readable storage media of claim 15 wherein indicating the network slice to the user device comprises transferring a registration accept message to the user device that directs the user device to begin a Protocol Data Unit (PDU) session over the network slice and that includes a User Equipment Route Selection Policy (URSP) rule that directs the user device to route the user data to the network slice.

19. The computer readable storage media of claim 15 wherein routing the user data to the edge security service based on the secondary authentication comprises routing the user data to a Secure Access Service Edge (SASE) that enforces the security policies on the user data and delivers the user data to the enterprise network.

20. The computer readable storage media of claim 15 wherein:
the network slices comprise at least one of an Ultra-Reliable Low-Latency Communications (URLLC) slice, a Massive Internet-of-Things (MIT) slice, an Enhanced Mobile Broadband (eMBB) slice, or a Vehicle-to-Anything (V2X) slice; and
the security policies comprise one or more of content filtering, security features, malware scanning, Domain Name Service (DNS) filtering, firewalls, intrusion detection, or intrusion prevention.
